(19) United States
(12) Patent Application Publication
(10) Pub. No.: US 2023/0061813 A1
(43) Pub. Date: Mar. 2, 2023

(54) SYSTEMS AND METHODS FOR PROGRAMMABLE PAYMENTS ENABLED BY TRIGGERS BASED ON MUTUAL VALIDATION

(71) Applicant: JPMORGAN CHASE BANK, N.A., New York, NY (US)

(72) Inventors: Liu DAPENG, Singapore (SG); Hendrik Tanjaya TAN, Singapore (SG); Naveen MALLELA, Singapore (SG); Muh Hwa LEE, Singapore (SG); Aloysius Lim Wai LIANG, Singapore (SG); Stanley Yong Wai KEONG, Singapore (SG)

(21) Appl. No.: 17/823,250

(22) Filed: Aug. 30, 2022

Related U.S. Application Data
(60) Provisional application No. 63/238,683, filed on Aug. 30, 2021.
(60) Provisional application No. 63/238,672, filed on Aug. 30, 2021.

(51) Int. Cl. G06Q 40/02; G06F 8/34

(52) U.S. Cl. CPC G06Q 40/02; G06F 8/34

(57) ABSTRACT

A method may include (1) receiving, at a client electronic device executing a visual programming language, a plurality of visual programming blocks, wherein each visual programming block is associated with a banking system, a baking transaction, or an account, and wherein the visual programming blocks are configured to graphically interface in a manner consistent with a banking action; (2) verifying, by the client electronic device, that an account associated with one of the visual programming blocks is active; and (3) deploying, by the client electronic device, a computer program comprising the plurality of visual programming blocks to a computing system in a production environment, wherein the computer system executes the computer program. The computer program is configured to listen for an event, identify a trigger condition in the event, and execute an action in response to the event.

### RELATED APPLICATIONS

This application claims priority to, and the benefit of, U.S. Provisional Patent Application Ser. No. 63/238,683, filed Aug. 30, 2021, and U.S. Provisional Patent Application Ser. No. 63/238,672, filed Aug. 30, 2021, the disclosures of which are hereby incorporated, by reference, in their entireties.

### BACKGROUND OF THE INVENTION

### 1. Field Of The Invention

Embodiments generally relate to systems and methods for programmable payments that verifiably execute instructions based on mutually observable trigger events.

### 2. Description of the Related Art

The term “programmable money” may be interpreted in multiple ways depending on the context where it is used. For most in the cryptocurrency world, the term refers to currency units represented on a blockchain or similar system whose use or behaviors within the consensually maintained shared state can be controlled by unattended scripts. These unattended scripts are commonly seen as being instances of the autonomously executing “smart contracts” that are used in Ethereum-inspired blockchains.

Outside of cryptocurrency circles, programmable money refers to the opportunities for automation of operations on customer bank accounts through application programming interfaces (APIs) provided by banks to third party providers (TPP).

### SUMMARY OF THE INVENTION

Systems and methods for programmable payments that verifiably execute instructions based on mutually observable trigger events are disclosed. In one embodiment, a method may include (1) receiving, at a client electronic device executing a visual programming language, a plurality of visual programming blocks, wherein each visual programming block is associated with a banking system, a baking transaction, or an account, and wherein the visual programming blocks are configured to graphically interface in a manner consistent with a banking action; (2) verifying, by the client electronic device, that an account associated with one of the visual programming blocks is active; and (3) deploying, by the client electronic device, a computer program comprising the plurality of visual programming blocks to a computing system in a production environment, wherein the computer system executes the computer program. The computer program is configured to listen for an event, identify a trigger condition in the event, and execute an action in response to the event.

In one embodiment, the computing system may include an agent, and the agent may include an event listener that listens to a message bus for an event and identifies the trigger condition for the event, and an action picker that picks an action in the computer program to execute in response to the trigger condition.

In one embodiment, the banking action may include a transfer or a hold.

In one embodiment, the banking action may include an off-chain action involving an off-chain account.

In one embodiment, the banking action may include an on-chain action.

According to another embodiment, a system may include: a client device executing a client programming program; a financial institution backend comprising an agent, the agent comprising an event listener and an action picker; and an interface that interfaces with a plurality of financial institutions. The client programming program generates a program identifying an account, a trigger condition, and an action. The financial institution backend deploys the program to the agent. The event listener listens for an event on a message bus, the event received from the interface and determines that the trigger condition for the event is met. The action picker identifies the action from the program for the trigger condition. The agent executes the action.

In one embodiment, the plurality of financial institutions are part of a distributed ledger network.

In one embodiment, the interface receives the event by API.

In one embodiment, the agent comprises an on-chain agent and an off-chain agent.

In one embodiment, the event is related to a transaction.

In one embodiment, the system may also include a simulator in a sandbox that simulates execution of a transaction. The simulation may return a liquidity status of an account involved in the transaction. The simulation may be executed in response to the trigger condition being met and before the action is executed. The trigger condition may be based on an account identifier in an event.

According to another embodiment, a method may include: (1) receiving, by an event listener, first program code comprising a trigger condition; (2) receiving, by an action picker, second program code comprising action to take in response to the trigger condition; (3) monitoring, by the event listener, a message bus or API for an event meeting the trigger condition; (4) determining, by the event listener, that the trigger condition is met; (5) identifying, by the action picker, the action for the trigger condition; and (6) executing, by the action picker, the action.

In one embodiment, the message bus or API receives the event from distributed ledger network.

In one embodiment, the event comprises a transaction involving an account.

In one embodiment, the method may also include simulating, by a simulator, execution of the action before the action picker executes the action.

In one embodiment, the program code is received from a client using executing a visual programming language.

In one embodiment, the event listener receives a plurality of trigger conditions, and the action picker receives a plurality of actions, the event listener determines that a plurality of trigger conditions are met by the event, and the action picker executes a plurality of the actions.

According to another embodiment, a non-transitory computer readable storage medium, may include instructions stored thereon, which when read and executed by one or more computer processors, cause the one or more computer processors to perform steps comprising: receiving a plurality of visual programming blocks, wherein each visual programming block is associated with a banking system, a baking transaction, or an account, and wherein the visual programming blocks are configured to graphically interface in a manner consistent with a banking action; verifying that an account associated with one of the visual programming blocks is active; deploying a computer program comprising the plurality of visual programming blocks to a computing system in a production environment, wherein the computer system executes the computer program; and listening for an event, identify a trigger condition in the event, and executing an action in response to the event.

In one embodiment, the computing system may include an agent, and the agent may include an event listener that listens to a message bus for an event and identifies the trigger condition for the event, and an action picker that picks an action in the computer program to execute in response to the trigger condition.

In one embodiment, the banking action may include a transfer or a hold.

In one embodiment, the banking action may include an off-chain action involving an off-chain account.

In one embodiment, the banking action may include an on-chain action.

According to another embodiment, a non-transitory computer readable storage medium, may include instructions stored thereon, which when read and executed by one or more computer processors, cause the one or more computer processors to perform steps comprising: receiving first program code comprising a trigger condition; receiving second program code comprising action to take in response to the trigger condition; monitoring a message bus or Application Programming Interface (API) for an event meeting the trigger condition; determining that the trigger condition is met; identifying the action for the trigger condition; and executing the action.

In one embodiment, the message bus or API receives the event from distributed ledger network.

In one embodiment, the event comprises a transaction involving an account.

In one embodiment, the non-transitory computer readable storage medium, may also include instructions stored thereon, which when read and executed by one or more computer processors, cause the one or more computer processors to simulate execution of the action before execution of the action.

In one embodiment, the program code is received from a client using executing a visual programming language.

In one embodiment, the non-transitory computer readable storage medium, may also include instructions stored thereon, which when read and executed by one or more computer processors, cause the one or more computer processors to receive a plurality of trigger conditions, receive a plurality of actions, determine that a plurality of trigger conditions are met by the event, and execute a plurality of the actions.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for programmable payments that verifiably execute instructions based on mutually observable trigger events according to an embodiment;

FIG. 2 depicts a financial institution architecture according to an embodiment;

FIG. 3 depicts a method for programmable payments that verifiably execute instructions based on mutually observable trigger events according to an embodiment; and

FIG. 4 depicts an exemplary computing system for implementing aspects of the present disclosure.

### DETAILED DESCRIPTION OF PREFERRED EMBODIMENTS

Embodiments relate generally to systems and methods for programmable payments that verifiably execute instructions based on mutually observable trigger events. For example, embodiments may include an infrastructure that enables clients to compose callable scripts that are made up of addressable objects, schedules, events, conditional statements, actions, calculations and notifications. These objects, schedules, events, conditions, and/or actions may be made available to the clients. The scripts are executed when the caller observes some mutually observable event or against a specific schedule. If any of the conditions within a script is met at that point in time, the associated action may be initiated, and a notification may be sent as required.

Embodiments may require at least some of the following conditions: (a) a caller may start execution of a one or more script according to the event triggers or schedules without delays and mistakes (a script that takes action too late or not at all when required can be as harmful to a client's interests as a script that takes excessive actions); (b) the conditions may be evaluated within the specification that the script writers were given, hence mathematical calculations and logical operations in script statements are carried out exactly as the documentation describes; (c) any objects or values used within the statements are evaluated within the conditions or actions to be correct and consistent; and (d) actions that are initiated are carried out with the correct parameters. For instance, a payment action would be expected to send a properly formatted payment instruction to the right payment system with the right payee and payer accounts, and the right value in the right currency.

Amongst these conditions, errors that result in problems may only be detected after the fact and are not in principle recoverable without external intervention. Correctness of the type described in part (b) may be enforceable through the presence of at least two fully independent implementations of the script evaluation engine whose calculations can be compared at each step and mutually validated. Correctness of the type described in part (c) may be enforced by ensuring through cryptography that the objects, such as bank accounts, being referred to in statements are immutable and unambiguously linked to a single source of truth. Correctness of the type described in part (d) may be subject to mutual validation. When an action is initiated, the affected stakeholders can be notified and their explicit sign-off given before the next steps within the action are undertaken.

As disclosed herein, instead of providing the commercial agents of clients with temporally limited access to rigid ways of interacting with accounts, embodiments allow customers to post persistent software agents that operate their accounts in a well-defined and unattended way.

In embodiments, an agent-based modelling (ABM) approach to programmable money fits well within the context of shared state consensus systems like Ethereum. The Ethereum Virtual Machine (EVM) within each node simulates the outcome of running the set of instructions (opcodes) in a sandboxed and isolated environment. In this environment, software agents may have complete unambiguous knowledge of the current environment.

In the current application domain, agents are assumed to be either simple reflex agents whose actions are based on conditional-actions that can be written as “if-else” statements. Such agents do well in fully observable environments and make optimal decisions. Embodiments may involve an environment with some degree of non-observability with respect to properties of other agents, and as a consequence, agents that act according to a hard-coded rule assuming that other agents will act in a certain manner can fail.

In embodiments, a single event may trigger more than one event trigger, and the corresponding scripts for those event triggers may be executed.

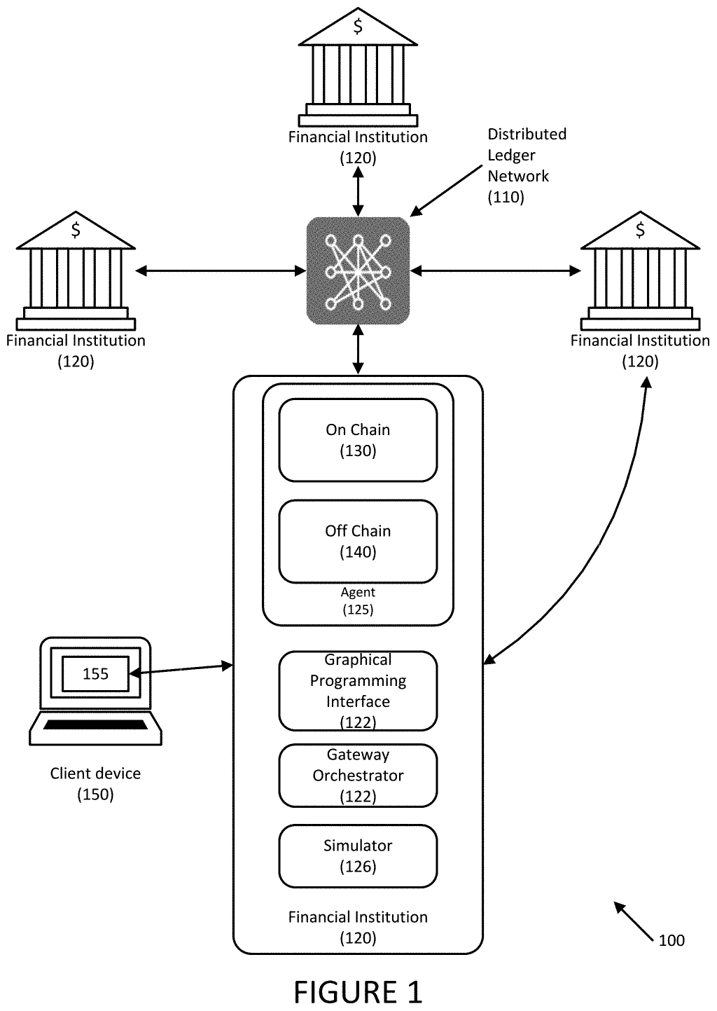

Referring to FIG. 1, a system for programmable payments that verifiably execute instructions based on mutually observable trigger events is disclosed according to an embodiment. System 100 may include distributed ledger network 110 that may include a plurality of nodes 120, such as financial institutions, banks, FinTechs, etc. Distributed ledger network 110 may be any suitable network that supports cryptographically verifiable and immutable transactions, such as a blockchain based network. An example of a suitable network is an Ethereum-based network.

In embodiments, one or more financial institution 120 may instead communicate directly with another financial institution 120 by, for example, an Application Programming Interface (API).

Each financial institution 120 may include graphical programming interface 122 and agent 125. Agent 125 may include on-chain agent 130 and off-chain agent 140. Graphical programming interface 122 may interface with client device 150 via application 155, which may be a computer program, a browser, etc.

System 100 may further include simulator 126, which may be provided in a sandboxed environment in financial institution 120. Simulator 126 may be provided to reflect the behavior of the system that eventually execute the program. Simulator 126 may simulate the execution of code from graphical programming interface with actual and/or synthetic transactions or events. The results of the execution may be used to validate the execution of the code. For example, if the code is validated, it may then be deployed to agent 125.

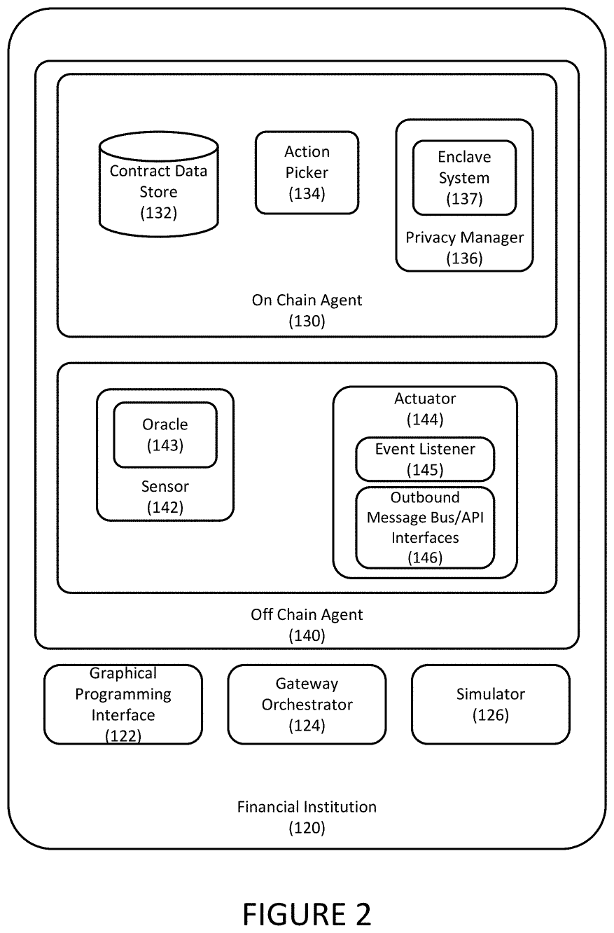

Referring to FIG. 2, on-chain agent 130 may include contract data store 132, action picker 134, and privacy manager 136 that may include enclave system 137. Off-chain agent 140 may include sensor 142 and actuator 144, which may include event listener 145 and outbound message bus/API 146.

Sensor 142 may receive information from an environment, and may generate “percepts” for the information. A percept refers to an agent's perceptual inputs at a given instant in time. For example, event listener 145 may listen to a messaging bus (not shown) for an event that meets one or more trigger condition.

Sensor 142 may then provide a trigger, or the percept, to action picker 134, which may apply conditions (e.g., if-else statements) and properties to select one or more action for each trigger condition that is met. Note that more than one trigger condition may be met, and more than one action may be taken. Agent 125 may then actuate actuator 144 to execute the selected actions.

Sensor 142 may be deployed to off-chain agent 140, or to on-chain agent 130.

Sensor 142 may be provided with oracle 143. In one embodiment, sensor 142 and oracle 143 may be deployed to on-chain agent 130 in an Oraclize-like model. In another embodiment, sensor 142 and oracle 143 may be deployed to off-chain agent 140 in a reality-keys like model, where oracle 143 calls directly into the percept contract on chain.

A plurality of agents 125 may be provided as is necessary and/or desired. For example, one agent 125 may be deployed per account, per client, etc. In another embodiment, one agent 125 may be deployed for multiple accounts, clients, etc.

In one embodiment, agent 125 may have a scope that is commensurate with its environment. Examples may include nostro deposit accounts and transfers between these accounts; non-interest bearing “coin” (e.g., ERC20 tokens, stablecoins, nonfungible tokens (NFTs), etc.) deposit accounts for customers; non-interest bearing coin deposit accounts denominated in another currency; non-interest bearing “coin” deposit accounts for customers of other banks; interest bearing “coin” deposit accounts for all customers. Note that these scopes are exemplary only and other scopes may be used as is necessary and/or desired.

In embodiments, agent 125 may be aware of the balances within non-coin accounts held by the same owner of agent 125. Agent 125 may then execute actions that may affect coin and non-coin balances, such as sweeping funds between them for liquidity optimization.

Agent 125 may have an owner, a posting time/date, a first initiation time/date, an expiration time/date, working hours, triggering mechanism (e.g., a time oracle, event oracle, etc.), a reporting branch code, one or more accounts under control, and a percept sequence. A percept sequence may be a complete history of observations up to the present time. The percept sequence for each agent 125 may be truncated, or complete. Agent 125 may make use of a truncated percept sequence if it deals with episodic events (e.g., monthly recurring salary payments at the end of month). Agents 125 may use a complete percept sequence if they operate in a sequential environment.

Actuator 144 may be a mechanism by which agent 125 is able to change its environment. For example, actuator 144 may make changes to the state of an Ethereum Virtual Machine (EVM) that may result in the emission of events that external modules can pick up to carry out actions on its behalf.

Agent 125 may further include a trigger word list. In one embodiment, a trigger word list gives agent 125 a generic capability to do simple word-based pattern matching within a free text or structured data field. For example, agent 125 may have access to a data feed about the incoming payments credited to the user's bank account, and the details of the incoming payments may include structured data identifying the payer, one or more fields of which are related to the address of the payer. Agent 125 may be directed to check one or more of these address fields for the existence of a keyword, or a pattern of words, to decide on its course of action. The capability may be used to build logic that acts like a conditional payment, where a payment out to a supplier is made only when a corresponding payment is received from a customer at a certain address. Similarly, this capability may be used to decide on the supplier that is paid based on keywords within the reference data related to an incoming payment identifying the item that was paid for.

In embodiments, one or more properties for agent 125 may be identified as mutable or immutable. This may be an explicit choice that the designer of agent 125 can set as there may be reasons to allow for updating of properties based on changing needs. For example, the deposit accounts that agent 125 controls may expand or shrink over time as is necessary and/or desired.

The ownership and the accounts under the control of each agent 125 may be considered to be confidential information (CI). Therefore, the information in those fields may be restricted from access. Protective measures against unauthorized access to personally identifiable information (PII) such as person names, addresses and government issued identity numbers may be implemented as is necessary and/or desired. Privacy manager 136 may provide such services.

Selective observability may be achieved through the use of enclave systems 137. systems such as Tessera (Java), Crux (GoLang) enclaves, etc. Those enclave systems tie the access to private transactions to the storage model of the underlying blockchain network, which would mean that in an operating model where clients do not maintain their own nodes but run on a common infrastructure, the private information is still stored potentially in a common medium that is behind the enclave's interface. This may itself be a breach of information commingling standards, but where such concerns do not exist is the preferred solution.

In one embodiment, Personal Identifying Information (PII) may be protected by using proxies that are created for the same information via secure hash algorithms. These may be adequate for certain types of free text PII, such as addresses, where the likelihood of a brute force attack succeeding is small. Hashing may not protect against linking of simpler PII, such as government issued identity numbers, Legal Entity Identifiers (LEIs) of companies, or even institution names as those can trivially be hashed into a look-up dictionary and uncovered by brute force.

In embodiments, agent action types may fall into four categories: (1) modify the agent's own properties, (2) modify the properties of other agents, (3) update the agent's decision rules, and (4) issue instructions to actuators that affect non-agents. Additional or fewer agent action types may be provided as is necessary and/or desired.

Examples of agent actions may include the following. Agent 125 that has reached the end of its life may recognize this when next called, and may self-destruct. This is not a modification of the agent 125's own properties, but a modification of the entire environment as agent 125 is removed entirely from it. Agent 125 that is designed to carry out interest rate optimal sweeps at the end of each designated work day may have full knowledge of the account balances in each of the source funding accounts, full knowledge of the sweep structure and the list of potential header accounts, full knowledge of the interest rates paid on each branch for the same currency, actions that emit debit events to the external direct deposit account system, trigger issuance to the on chain DDA, actions to debit the on chain DDAs that will be sources, and actions to emit credit events to the optimal header account on chain. A simple escrow agent 125 may have full knowledge of the account balances in each of the two source funding DDA, knowledge of the conditions that will allow for the release of holds on funds and the execution of the transfer of funds, actions to hold funds in the two source DDA, actions to release holds on funds, and actions to debit and credit the balances in the target DDA on chain. A modifiable timed escrow agent 125 may have full knowledge of the account balances in each of the two source funding DDA, knowledge of current time, knowledge of the conditions that will allow for the release of holds on funds and the execution of the transfer of funds, actions to hold funds in the two source DDA, actions to release holds on funds, actions to debit and credit the balances in the target DDA on chain, and actions to modify the agent's earliest time of funds release.

Agent 125 may have rules that define how it picks actions and updates properties.

In one embodiment, a scheduling mechanism that may determine when agent 125 is called, the order in which multiple agents 125 is executed amongst a list of agents 125 from different users may be provided. An activation order may be used that specifies the order in which agents 125 are “awoken” and start execution of their observation-decision cycle. Agent 125 may be updated when it has gone through an observation-decision cycle is complete. There may be an action taken or a null operation based on the decision of agent 125.

A tick is a discrete time step during which every agent 125 that has to be updated is updated. It is the smallest amount of time that is addressable by the activation regime. Even within a single tick, we have an order of execution for agents 125, with some proceeding first, and others later.

Fairness type 1 is concerned with making progress over time. It is defined in this context as giving time to each agent 125 such that they are all able to make progress towards their goals equally within a window (which may be more than a single tick). This type of fairness is affected by the relative complexity of the “work” that each agent takes in the observation-decision and optionally, action cycle. If some agents 125 cannot execute because the aggregate sum of work required exceeds that which can take place physically within a tick, then it is important to assure the agents 125 that they will eventually get executed. One way to ensure this is to allocate a fixed amount of physical time or a computational budget to each agent 125 to spend within a single tick.

Fairness type 2 is concerned with access to scarce resources. In a multi-agent setting where agents 125 compete for a limited resource all agents have a probabilistically equal chance to secure access in each tick. This type of fairness is affected by the activation order if either being consistently first or last is preferred from a competitive perspective. Randomization of an activation order is a potential solution.

With payments, fairness considerations may impact the ability of clients to meet cut-off times for external systems, and the clients may face financial damages for late payments or be seen to have defaulted on critical obligations.

In a single agent universe, there is no need to consider concurrency. However, if there is more than one agent 125, the multi-agent environment may employ rules to prevent a poorly written agent 125 from falling into an infinite loop and thereby excluding other agents 125 from executing at all. Equivalent bad situations can occur if one agent 125 has to wait for actions to complete in a sequence within the same tick. If one agent 125 is “blocked” in this sense and there is no way for the scheduler to switch execution to another agent 125, then the outcome is unfair.

An exemplary implementation is as follows. A scheduler may be set to allow each agent 125 to decide when to surrender control over the execution thread to the next agent 125 on the list. In addition, every action started by one agent 125 may be completed before control is returned to the control thread. With these constraints, a total ordering that is consistent both on and off-chain may be developed. This may be an important property for certain environments, such as agents that send payments out from a limited pool of money. The first agent 125 running would send a payment request out, and the payment would complete before a second agent 125 is allowed to draw on the same pool of funds. There is no danger that a second, simultaneously executing agent, draws down on the same pool and leaves the payment to fail.

The simplest case is likely to be type 2 unfair as earlier agents 125 always reach their goals first. It may or may not be type 1 unfair depending on the amount of work that can be completed in one tick.

Embodiments may consider the confounding effects of choices with respect to the maximum number of blocks that comprises a discrete action that an agent can take (this caps the time complexity of an agent as well), the block time versus the latency of external systems connected to the sensors and actuators, and the number of agents that can run, and service level agreements on their responsiveness and latency.

Embodiments may provide low latency processing, the ability to run many scripts concurrently without a “slowing down” effect, and the ability to process a massive amount of events in an instant. Embodiments may provide service legal agreement (SLA) management, whereby client may write and deploy their own scripts. Embodiments may provide the ability to observe transaction and event latencies end-to-end on a real-time basis, and adopt “smart” proactive preventive measures before service disruption happens, and a data driven approach to managing service levels with dependent system partners.

Concurrency may be handled by, for example, using a priority flag, a target time slice for execution (set to a length of time, e.g., 5 minutes, that is long enough for most actions to complete), etc. Embodiments respect the priority flags when running agents 125 from the same account owner by sorting the higher priority agents to run first. In embodiments, competing agents 125 may be owned by other owners.

Embodiments may simulate a net impact of running all agents 125 across all users within the same target time slice (which is a single tick), and decide a total ordering before executing the entire set of resulting actions on chain and off-chain through the actuators. For example, simulator 126 may load one/multiple programs/code together. Loading multiple programs/code together may provide additional insights as to how the programs/code impact each other.

Simulator 126 may then load accounts, and set the account parameters (e.g., opening balance, credit limit, etc.). The account parameters may be adjusted for different simulations to see the changes to account liquidity.

Simulator 126 may import known transactions or create synthetic transactions. This may provide insights on how these transactions might impact account liquidity throughout the day.

Using a defined simulation period, such as a start and an end time, simulator 126 may run the simulation. The results of the simulation may define a simulation period (i.e., a start and an end time) and may then run the simulation using the known or synthetic transactions. The results of the simulation may be analyzed. For example, diagrams and/or charts of the different parameters related to account liquidity (e.g., balance, max credit utilization, etc.). The simulation setup may be saved.

In one embodiment, simulator 126 may simulate the execution of an action before it is actually executed. For example, event listener 145 may identify an event that meets a trigger condition, and then simulate the action selected by action picker 134. If the simulation is successful (e.g., liquidity is goals were met), the action may then be executed. If the simulation is unsuccessful, a message may be generated, and the action may be held pending resolution of any issues.

In embodiments, a user may interface with graphical programming interface 122 using client device 150, which may be any suitable electronic device (e.g., computers, smartphones, Internet of Things (IoT) devices, terminals, kiosks, etc.). Embodiments are directed to visual programming language interface for composition of triggers. For example, embodiments may use “blocks” that are specific and contextual to account services and payment services provided by banks to compose triggers which are multi-bank and multi-organizational in nature. The visual programming language then compiles into byte code. The byte code may then be provided to one or more agent 125. For example, the code may be deployed to action picker 134.

For example, embodiments may provide the following “blocks” to use a visual programming environment: ownership and access control; private percepts; shared percepts; control (e.g., looping, conditional statements, etc.); operators (e.g., logic, mathematical functions, etc.); data (e.g., properties associated with the agent or other agents that are accessible); actuators (e.g., these allow for changes to the environment such as interactions with other agents); etc.

In embodiments, certain programming blocks may provide certain functionality and may be associated with, or linked to, one or more system, account, etc. For example, account blocks may be associated with an account that may be maintained on a shared distributed ledger, in a bank system, etc.

In one embodiment, during programming, embodiments may validate account details, available balances, etc. For example, the program may not be executed if the incorrect account is identified.

In one embodiment, the programming may identify one or more trigger conditions, actions to take, timing, etc. in response to the occurrence of an event. In one embodiment, a programming block may be associated with a bank system, a third-party system, a data stream, that may provide events that may be used to trigger an action. In one embodiment, an event may “wake up” systems to determine whether a trigger condition is met.

For example, for a transaction event, a trigger condition may be set up based on a certain account reference. Thus, when the account reference is identified in a monitored event, an action, such as transferring funds to another account, may be taken.

In embodiments, the program may check third party systems, for example, court ordered holds, anti-money laundering checks, fraud checks, etc.

In one embodiment, each financial institution 125 may include a plurality of internal systems (not shown) that provide transaction events to a gateway orchestrator 124. Gateway orchestrator 124 may receive the internal transactions for financial institution 125 from, for example, a messaging bus (not shown), API, a messaging system (not shown) and may aggregate them into a single component. It may then externalize the single component to a central bank-agnostic infrastructure that may extract the transaction events from the single component and then execute scripts as is necessary.

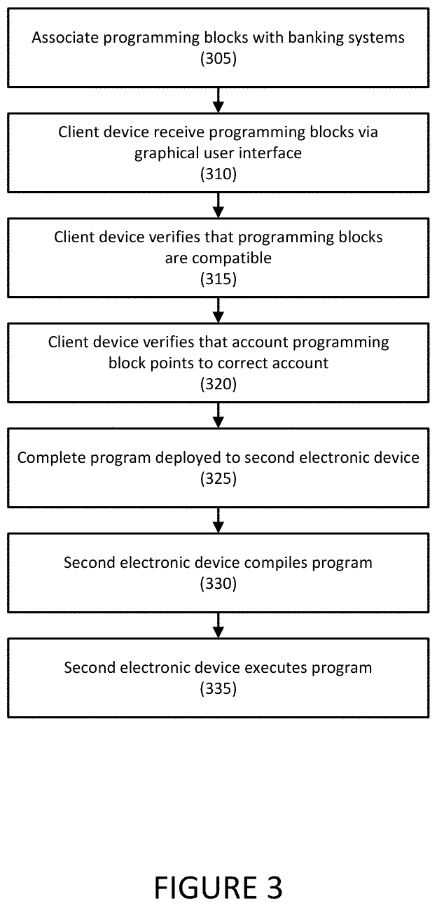

Referring to FIG. 3, a method for using a visual programming language is disclosed according to an embodiment.

In step 305, a client electronic device executing a visual programming language may receive, via an interface, visual programming blocks may be associated with banking systems or accounts. For example, a block may be provided with an identifier for an account (e.g., routing number and account number), an address or identifier on a distributed ledger, etc. As another example, a block may be associated with a banking system, such as a fraud system, a database, a third-party system (e.g., OFAC systems or databases), etc.

An example of a programming block may include an optimizer that includes a foreign exchange (FX) component and a security component. For a specific base currency, a client may define, within the block, the FX rates (for different quote currencies), source of rates, and the minimum update frequency of the rates desired. The optimizer may read the rates during run-time and pick the optimal one based on the availability of the quote currency to purchase the required quantum of base currency. This would then top-up the available balance of the account, and enable the sending of a large payment.

This is particularly useful if the client does not have recurring need for the quote currency. For instance, the payment may be required in Vietnam Dong (VND) which the client has no natural liquidity in. The client naturally holds EUR, SGD, USD. The optimizer would obtain rates for all pairs of: VND/EUR, VND/USD, VND/SGD. It would look up the available balances of USD, EUR and SGD, and find the best mixture of FX transactions to get the cheapest way to obtain the VND required. The optimizer would need to be aware of the cross rates of USD/SGD, USD/EUR, EUR/SGD as well to determine the relative prices.

For a client that has connected their securities portfolio balances to the bank, embodiments may look up the relative cost of executing intra-day repurchase transactions using their securities to obtain liquidity in the necessary currency for payments.

In step 310, the client electronic device may receive a plurality of programming blocks. In one embodiment, the blocks may be configured to interface in a certain manner. For example, the visual programming blocks may graphically interface only in a manner that is consistent with an actual banking action.

In step 315, as programming blocks are added, the client electronic device may verify that the programming blocks are compatible and can interface with each other. For example, like puzzle pieces, certain programming blocks may be shaped to only interface with certain programming blocks, which may prevent, for example, two account blocks from being placed next to each other without some sort of operation between them.

In step 320, the client electronic device may verify that account blocks are linked to the proper accounts. For example, the client electronic device may verify that the account associated with a certain block is an active account and is eligible for the intended transaction.

In step 325, once the program is complete, the program may be deployed to one or more second electronic devices.

In step 330, a second computing system, such as a simulator or in a production environment may compile the visual programming language program into executable code, and, in step 335, the second computing system may execute the program. For example, an agent, which may be deployed on-chain and/or off-chain, may monitor an environment using a sensor. When a certain event occurs, an actuator may execute the code.

For example, the simulator may execute the program and may display results to users for analysis. Users may conduct their own “what-if” assessment about the suitability of the code in meeting their needs.

As another example, execution may happen in a production environment, such as a bank system, with “real money” and accounts.

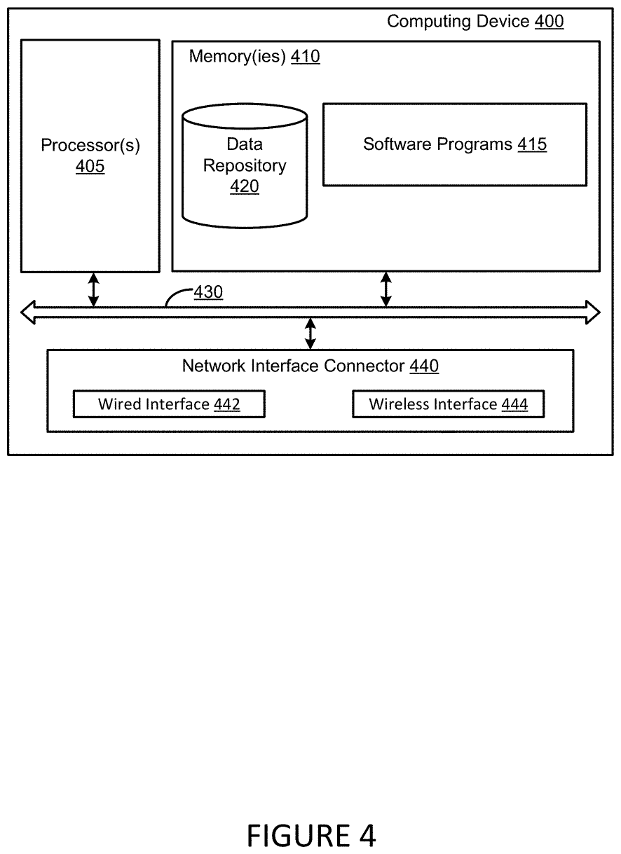

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method comprising:
receiving, at a client electronic device executing a visual programming language, a plurality of visual programming blocks, wherein each visual programming block is associated with a banking system, a baking transaction, or an account, and wherein the visual programming blocks are configured to graphically interface in a manner consistent with a banking action;
verifying, by the client electronic device, that an account associated with one of the visual programming blocks is active;
deploying, by the client electronic device, a computer program comprising the plurality of visual programming blocks to a computing system in a production environment, wherein the computer system executes the computer program;
wherein the computer program is configured to listen for an event, identify a trigger condition in the event, and execute an action in response to the event.

2. The method of claim 1, wherein the computing system comprise an agent, and the agent comprises an event listener that listens to a message bus for an event and identifies the trigger condition for the event, and an action picker that picks an action in the computer program to execute in response to the trigger condition.

3. The method of claim 1, wherein the banking action comprises a transfer or a hold.

4. The method of claim 1, wherein the banking action comprises an off-chain action involving an off-chain account.

5. The method of claim 1, wherein the banking action comprises an on-chain action.

6. A system, comprising:
a client device executing a client programming program;
a financial institution backend comprising an agent, the agent comprising an event listener and an action picker; and
an interface that interfaces with a plurality of financial institutions;
wherein:
the client programming program generates a program identifying an account, a trigger condition, and an action;
the financial institution backend deploys the program to the agent;
the event listener listens for an event on a message bus, the event received from the interface;
the event listener determines that the trigger condition for the event is met;
the action picker identifies the action from the program for the trigger condition; and
the agent executes the action.

7. The system of claim 6, wherein the plurality of financial institutions are part of a distributed ledger network.

8. The system of claim 6, wherein the interface receives the event by Application Programming Interface (API).

9. The system of claim 6, wherein the agent comprises an on-chain agent and an off-chain agent.

10. The system of claim 6, wherein the event is related to a transaction.

11. The system of claim 6, further comprising a simulator in a sandbox that simulates execution of a transaction.

12. The system of claim 11, wherein the simulation returns a liquidity status of an account involved in the transaction.

13. The system of claim 11, wherein the simulation is executed in response to the trigger condition being met and before the action is executed.

14. The system of claim 13, wherein trigger condition is based on an account identifier in an event.

15. A method comprising:
receiving, by an event listener, first program code comprising a trigger condition;
receiving, by an action picker, second program code comprising action to take in response to the trigger condition;
monitoring, by the event listener, a message bus or Application Programming Interface (API) for an event meeting the trigger condition;
determining, by the event listener, that the trigger condition is met;
identifying, by the action picker, the action for the trigger condition; and
executing, by the action picker, the action.

16. The method of claim 15, wherein the message bus or API receives the event from distributed ledger network.

17. The method of claim 15, wherein the event comprises a transaction involving an account.

18. The method of claim 15, further comprising:
simulating, by a simulator, execution of the action before the action picker executes the action.

19. The method of claim 15, wherein the program code is received from a client using executing a visual programming language.

20. The method of claim 15, wherein the event listener receives a plurality of trigger conditions, and the action picker receives a plurality of actions, the event listener determines that a plurality of trigger conditions are met by the event, and the action picker executes a plurality of the actions.
